(19) United States
(12) Patent Application Publication
(10) Pub. No.: US 2012/0184884 A1
(43) Pub. Date: Jul. 19, 2012

(54) VIBRATING BAND

(75) Inventors: Robert Dyer, Concord, MA (US); Michael J. Harrison, Princeton, NJ (US); Jason Kieke, Freehold, NJ (US); Benny S. Yam, Holmdel, NJ (US); Alfred J. Smetana, Wayne, NJ (US); Ian Gaylor, Cambridge (GB); Steven Bolkan, Hopewell, NJ (US); Gemma Evans, Royston (GB)

(73) Assignee: Church & Dwight Co., Inc., Princeton, NJ (US)

(21) Appl. No.: 13/394,872

(22) PCT Filed: Oct. 6, 2010
(86) PCT No.: PCT/US10/51674

§ 371 Date: Mar. 8, 2012

Related U.S. Application Data
(60) Provisional application No. 61/249,903, filed on Oct. 8, 2009.

(51) Int. Cl. A61H 1/00

(52) U.S. Cl. 601/46

(57) ABSTRACT

The present invention is directed to a vibrating band comprising a belt-like O-ring, a housing with a vibrating device contained within the housing. The vibrating device comprises a vibrating motor, one or more batteries and a touch or push switch. The vibrating band can be used by a male user to increase stimulation for both the male and his partner during sexual intercourse.

### REFERENCE TO RELATED APPLICATIONS This application is related to U.S. Provisional Application Ser. No. 61/249,903 filed Oct. 8, 2009, and takes priority therefrom.

### FIELD OF THE INVENTION

The present invention is directed to a vibrating band, which can be used to enhance sexual pleasure for both the user and the user's partner.

### BACKGROUND OF THE INVENTION

There historically have been many prior art devices developed to improve or aid sexual gratification, both for men and women. The devices designed for use by women are typically phallic in form and may or may not include a vibration device within. Those without a vibrator are intended for vaginal penetration and stimulation while those that vibrate are also intended for vaginal penetration and stimulation and additionally for clitoral and g-spot stimulation. Although these phallic shaped devices may be used for clitoral stimulation during intercourse, they must be hand held at such times, which limits the possible positions and comfort of one or both partners. Also, during intercourse such devices only stimulate locally and cannot stimulate the entire region surrounding the vagina.

Prior art devices designed for use by men are commonly in the form of a round constrictive ring that tightly surrounds the base of the penis. These devices are typically not intended to directly sexually stimulate or gratify either the man or his sex partner. Instead, they are primarily intended to improve erectile dysfunction problems of the man by trapping venous blood in the penis by means of localized constriction thereby aiding in the engorgement of the penis. A problem with these devices is that they are difficult to install and remove from the penis. Although there are some constrictive rings that have protuberances (both with and without vibrators attached) for the purpose of clitoral stimulation, the ring itself is still typically uncomfortably tight and awkward to install and remove which can hamper the flow and spontaneity of sexual intercourse.

Devices and appliances employable for sexual pleasure and gratification are well known in the prior art and are widely available to the general public. As previously mentioned, they include simple phallus-shaped structures provided with vibrator motors housed therein as exemplified in U.S. Pat. No. 5,573,499, for external and internal stimulation of body surfaces. The options available with such simple appliances are expandable by the use of couplings to interconnect the devices with handles or other such devices, as disclosed in published U.S. patent application Ser. No. 10/395,863. Other types of devices and appliances such as those described in U.S. Pat. No. 5,690,603, U.S. Pat. No. 5,853,362 and published U.S. patent application Ser. No. 10/797,634 have been ergonomically designed for ease of graspability and maneuverability to facilitate internal stimulation of certain organs and/or to enable concurrent use with a partner. However, such devices and appliances tend to be useful primarily for stimulation of phasic and tonic exteroreceptors that are situated in the epidermal and dermal layers immediately underlying internal and external body surfaces. Furthermore, their structural designs and operational controls typically require some degree of manual dexterity combined with muscular agility and fine motor control over body extremities. Accordingly, such devices and appliances are not particularly useful or satisfactory for focused stimulation of the deep-phasic pressure-sensitive receptors such as Pacinian corpuscles that are primarily distributed throughout the subcutaneous regions of the body.

Furthermore, erotic delight is a very important factor in marital relations for increasing the intimacy between the two genders; that is, erotic delight is not simply for propagation of progeny. During coitus, there is a great difference between the orgasm of the two genders: according to questionnaire data of THE KINSEY INSTITUTE NEW REPORT ON SEX, about 10% of the women fail to achieve orgasm no matter what method is used; and 50 to 75% of women fail to achieve orgasm simply relying on the reciprocation of the penis. Thus, there is a need for other techniques, such as stimulation of the clitoris to massage to climax. So the medical field suggests the use of erotic massage prostheses to stimulate the sexual sensitive region.

The “Vibrating Condom” of U.S. Pat. No. 5,377,692 discloses a vibrating condom or device having an inflatable vibrating region, which contacts the clitoris or vaginal walls and is activated by an electrical power unit for stimulating the most sensitive spot on a female partner's genitalia. Nevertheless, said patent design is not convenient for use as the embodiments of said patent require a tube to externally connect said electrical power unit, thereby increasing the difficulty in using the condom.

In U.S. Pat. No. 6,907,883, the inventor proposed an electric condom ring, specifically a condom ring having a miniature vibrating motor and a battery to be used on a condom to enhance male sexual function by means of the structure of the electric condom ring. The electric condom ring tightens up the portion of the penis local to its placement and vibrates, which is supposed to enhance the user's sexual pleasure. However, the electric condom ring, which can be used directly on the penis or with a condom, may also produce an uncomfortable feeling that may not promote orgasm in the user, and, contrary to its intent, may not increase usage of condoms. Furthermore, the miniature vibrating motor located along the ring only vibrates the penis, although the bulges located on the ring or its outer side may spontaneously touch the clitoris, but this makes for an awkward experience.

Accordingly, there is a need in the art for a versatile sexual enhancement device that is sexually stimulating to either a man or a woman during sexual intercourse, is easy to install and remove from a man's erect penis, and also one that can be easily and variably positioned on a man's erect penis.

### SUMMARY OF THE INVENTION

The vibrating band of the present invention is designed to increase the sexual pleasure for the male and his partner during sexual intercourse. It consists of a small vibrating motor or coin motor, one or more small batteries or button batteries, a microprocessor or microcontroller, a touch or push switch, which can be, for example, a dome or momentary switch, and a flexible circuitry board. All components are enclosed inside a soft SEBS (Styrene-Ethylene/Butylene-Styrene) block co-polymer housing portion or over-mold. A male can place the vibrating band anywhere on his penis for intercourse.

In one embodiment, the vibrating band of the present invention has a flexible circuitry board that allows the vibrating band to fit better on the penis.

In another embodiment, the vibrating band of the present invention has a water-proof design to keep the bodily fluids from damaging the internal components.

In yet another embodiment, the vibrating band of the present invention has a microprocessor for varying the intensity and speed of vibration.

### BRIEF DESCRIPTION OF THE DRAWINGS

FIG. 1—is a perspective view of the vibrating band of the present invention;

FIG. 2—is a schematic diagram of the vibrating device 10, in accordance with the present invention;

FIG. 3—is a perspective view of the vibrating band showing the placement of the flexible circuit board within the housing portion of the vibrating band;

FIG. 4—is a front view of the vibrating band of the present invention; and

FIG. 5—is a side view of the vibrating band of the present invention.

### DETAILED DESCRIPTION OF THE INVENTION

The present invention is directed to a vibrating band designed to increase the sexual pleasure for the male and his partner during sexual intercourse. It consists of a small vibrating motor or coin motor, one or more small batteries or button batteries, a microprocessor or microcontroller, a touch or push switch, which can be, for example, a dome or momentary switch, and a flexible circuitry board. All components are enclosed inside a soft SEBS (Styrene-Ethylene/Butylene-Styrene) block co-polymer housing portion or over-mold. A male can place the vibrating band anywhere on his penis for intercourse.

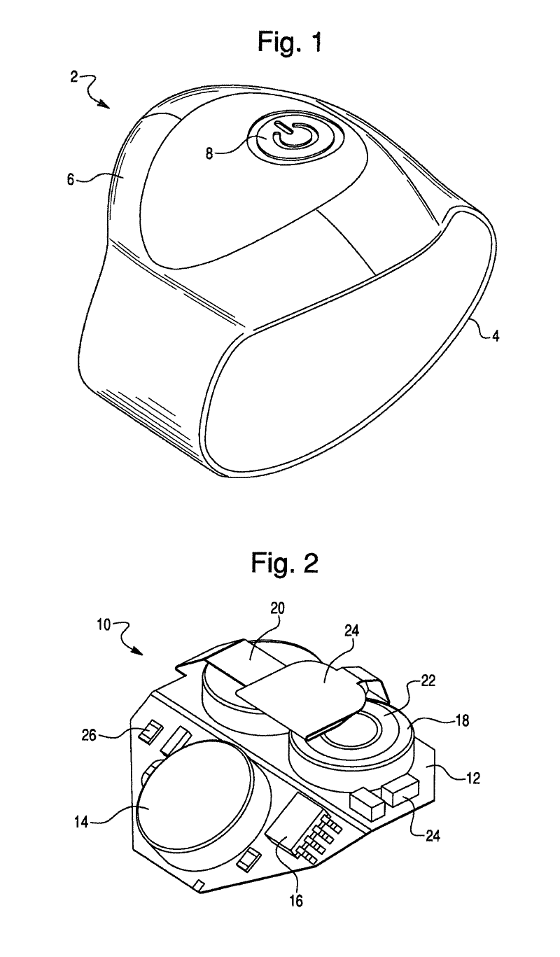

Referring now to FIG. 1, a perspective view of the vibrating band 2 of the present invention is shown. In accordance with the present invention, the vibrating band 2 comprises an elastic belt-like ring or O-ring 4, a housing portion 6 and a touch or push switch 8, which can be used to operate a vibrating motor (not shown). In one embodiment, the housing portion 6 is sealed to provide a water-proof environment for said vibrating device. In another embodiment, the elastic belt-like ring can expand up to about 20%, about 30%, about 40%, about 50% in diameter. Further, in accordance with this invention, the male user can place the vibrating band 2 anywhere on his penis for use during sexual intercourse with a partner. The belt-like ring 4 and the housing portion 6 can be made of any soft, flexible and non-toxic material. In one embodiment, the elastic belt-like ring or O-ring 4 and the housing portion 6 can be made of a rubber material. In general, any known non-toxic rubber material may be used. In another embodiment, the elastic belt-like ring or O-ring 4 and the housing portion 6 can be made of a silicone material. In general any known non-toxic silicone material may be used. In yet another embodiment, the belt-like ring 4 and the housing portion 6 can be made of polystyrene and elastomeric polymers, e.g., SEBS (Styrene-Ethylene/Butylene-Styrene) block co-polymers. The vibrating device (not shown) can be turned on via the touch on-off switch to increase the stimulation of both the male and his partner during sexual intercourse.

Referring to FIGS. 1 and 2 shows a schematic diagram of the vibrating device 10, in accordance with the present invention. The vibrating device 10 comprises a flexible circuitry board 12, a vibrating motor 14, a microprocessor 16, which optionally can vary the intensity and speed of the vibrating motor 14, and one or more batteries 18. The vibrating device 10 is placed inside the housing portion 6 of the vibrating band 2. The touch switch 8 can be any known switch type in the art. In one embodiment, the touch switch 8 can be an on-off switch for turning the vibrating motor on and off. In another embodiment, the touch switch 8 is a variable switch, allowing for optionally increased intensity and/or variable vibration speeds. In accordance with this embodiment, the flexible circuitry board 12 can include a microprocessor for optionally controlling the variation in intensity and/or speed of the vibrating motor 14. Example switches include, but are not limited to, a dome switch, a dimple switch, and a momentary button switch. The flexible circuitry board 12 can be any known flexible circuitry board known in the art. For example, the flexible circuitry board 12 can be a circuitry board made of Kapton® (DuPont, Delaware, USA) (polyimide film). The vibrating motor 14 can be any known small motor, such as a coin motor. Typically, the vibrating motor of the present invention will be from about 2 to 5 mm thick and have a diameter of from 5 to 20 mm. In another embodiment, the vibrating motor 14 will be from about 3 to 4 mm thick and from about 10 to 15 mm in diameter. In yet another embodiment, the vibrating motor 14 has a thickness of about 3.4 mm and a diameter of about 12 mm. The one or more batteries 18 can be any known batteries in the art, e.g., one or more button batteries. As shown, in one embodiment two button batteries can be used. Typically, the batteries are from about 2 to 5 mm thick and from about 5 to 20 mm in diameter. In another embodiment, the battery will be from about 3 to 4 mm thick and from about 10 to 15 mm in diameter. In yet another embodiment, the batteries have a thickness of about 3.1 mm and a diameter of about 11.6 mm.

In another embodiment, the vibrating device 10 of the present invention can contain additional components. For example, the flexible circuitry board 12 can include one or more capacitors 24 and one or more resistors 26. Other known components in the art can be included on the flexible circuitry board 12. The integrated circuitry board 12 may also contain one or more batteries 18 in place on the board. For example, as shown, the flexible circuitry board may contain a first flexible fold 20, which folds overtop of the one or more batteries 18 located on the flexible circuitry board 12, and which further contains copper traces thereby contacting or connecting the one or more batteries 18 in place. The flexible circuitry board 12 may contain a second flexible fold 24, which acts as a switch to turn the device on and off. In one embodiment, the second flexible fold 24 can be forced down onto the first flexible fold 20 through depression of the touch on-off switch 8. When a user presses the touch on-off switch the second flexible fold 24 is pressed down onto the first flexible fold 20, which in turn completes the circuit between the one or more batteries and the vibrating motor 14, thereby turning the vibrating motor 14 on, or off. In another embodiment, the vibrating motor can be controlled via a microprocessor, allowing for additional presses of the touch on-off switch to result in optionally increased intensity and/or variable vibrations speeds from the vibrating motor 14.

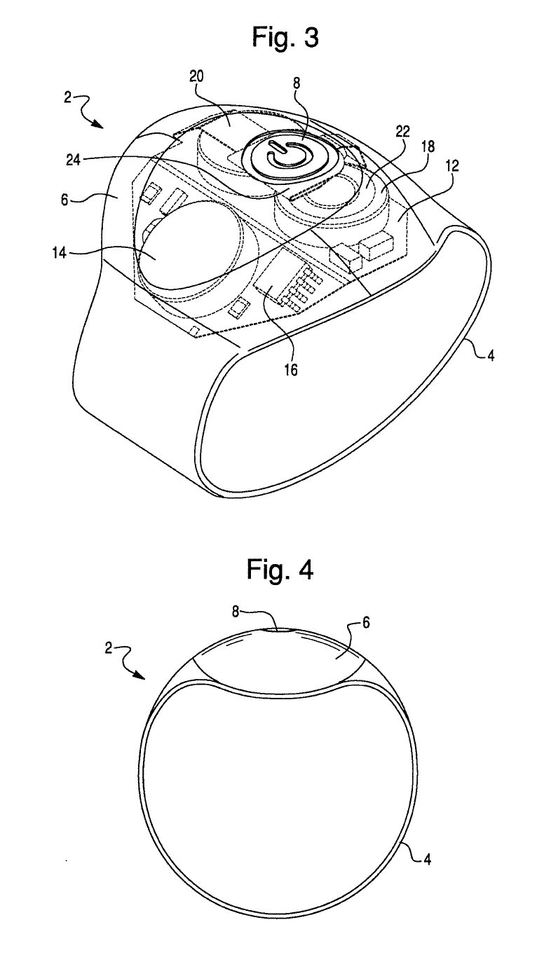

FIG. 3 shows a perspective view of the vibrating band showing the placement of the flexible circuit board within the housing portion 6 of the vibrating band. As shown, the vibrating device 10, including a flexible circuitry board 12, a vibrating motor 14, a microprocessor 16, which can optionally vary the intensity and speed of the vibrating motor 14, and one or more batteries 18. In one embodiment, the housing portion 6 is sealed to provide a water-proof environment for said vibrating device.

FIG. 4 shows a front view of a sexual vibrating band 2 of the invention, which is used to stimulate the male penis and the female vagina wall during sexual intercourse. In accordance with the present invention, the vibrating band 2 comprises an elastic belt-like ring or O-ring 4, a housing portion 6 and a touch switch 8, which can be used to operate a vibrating motor (not shown). In one embodiment, the housing portion 6 is sealed to provide a water-proof environment for said vibrating device. The vibrating band 2 of the present invention further contains a housing portion 6, which houses the vibrating device (not shown) therein and is connected to the belt-like ring 4. The belt-like ring or O-ring 4 and the housing portion 6 formed a single device, or sexual vibrating band 2. The housing portion 6 is a hollow structure which houses a vibrating device (not show). As discussed hereinabove, the sexual vibrating band 2 can be formed from a soft non-toxic rubber, elastic polymer or thermoplastic elastomer, which can be formed into a single piece. The sexual vibrating band 2 is an elastic belt-like ring or O-ring 4 typically with a thickness of from about 0.2 mm to about 2 mm. The housing portion 6 containing the vibrating device (not shown), which typically has a thickness from about 4 mm to about 6 mm, thereby providing a sleek or low profile design, which aids in comfort during sexual relations. Consequently, said design of the present invention can increase the stimulation of both the male penis and the female vagina wall during sexual relations.

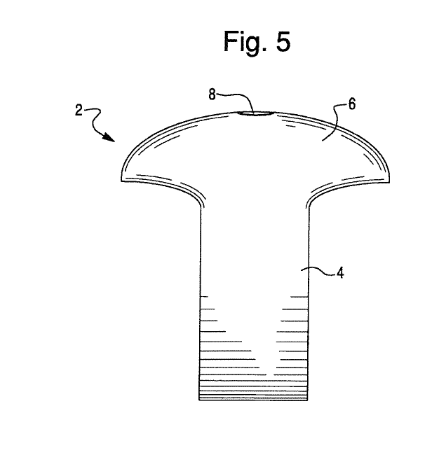

FIG. 5 shows a side view of the vibrating band 2 of the present invention. As shown, the vibrating band 2 comprises an elastic belt-like ring or O-ring 4 and a housing portion 6. The belt-like ring 4 and the housing portion 6 are made of a rubber of polymer and comprise a single piece. The housing portion further contains a touch switch 8, for operating the vibrating device (not shown).

In accordance with the present invention, prior to sexual relations, a male places the sexual vibrating band 2 over any area of his penis, typically on the shaft of the penis adjacent to the glans. The sexual vibrating band 2 is made of a soft non-toxic rubber material with the elastic, soft and perfectly fit characteristics; therefore, said sexual vibrating band 2 can be placed and closely attached to any portion of a male's penis without making him uncomfortable. In one embodiment, the male can place the vibrating band 2 on the penis and then wear a condom over top of the vibrating band 2. In another embodiment, the vibrating band 2 can be worn over top of a condom. Moreover, the invention provides the sexual vibrating band 2 for a male to wear at a non-specific position on his penis, so that he can place the sexual vibrating band 2 at any position or by any angle on his penis periphery and flexibly adjust or move the sexual vibrating band 2, depending on the position most desired during sexual relations. For example, the vibrating band 2 may be placed so as to stimulate the G-spot on his female partner's vagina wall. At any point, e.g., prior to sexual intercourse, the vibrating device 10 contained within the vibrating band 2 can be turned on for increased stimulation for both the male and female during sexual intercourse. In one embodiment, a variable switch and microprocessor can be used to optionally provide variable intensities and speeds of vibration.

The vibration effect of the vibrating device 10 during sexual relations stimulates the female's vagina wall enabling her to quickly reach orgasm, in addition, enabling her sexual partner to feel the vibrating stimulation on his penis through the vibration of the vibrating device 10. Consequently, the invention enables both female and male partners to enjoy increased mutual pleasures during sexual intercourse, settles the inability of a female to attain orgasm quickly because the vibrating stimulation of the invention shortens the time needed to reach orgasm, and reduces the physical strength of a male required during sexual activity.

In another embodiment, a male can wear the invention and subsequently place a condom over his penis and the vibrating band. The use of a condom will not alter the use or function of the vibrating band, and, in fact, can help to keep the vibrating band in place during use. The characteristics and advantages of the invention covered by this document have been set forth in the foregoing description. It is of course to be understood, however, that this disclosure is, in many respects, only illustrative. As one of skill in the art will understand, changes may be made without exceeding the scope and the spirit of the invention.

What is claimed is:

1. A vibrating band comprising: a belt-like elastic ring which can be placed over any portion of a male penis; an embedded assembly containing a vibrating device further comprising a flexible circuitry board, a vibrating motor, one or more batteries, and a touch switch for operating the vibrating motor.

2. The vibrating band of claim 1, wherein said elastic belt-like ring can expand at least about 50% in diameter.

3. The vibrating band of claim 1, wherein said flexible circuit board can flex to better fit said male penis, thereby providing additional comfort for the male and the male's partner.

4. The vibrating band of claim 1, wherein said belt-like ring and said housing are formed as a single piece.

5. The vibrating band of claim 1, wherein said vibrating device is enclosed within said housing portion providing a water-proof environment for said vibrating device.

6. The vibrating band of claim 1, wherein said belt-like elastic ring and said housing are made of rubber.

7. The vibrating band of claim 6, wherein said belt-like elastic ring and said housing are made of silicone.

8. The vibrating band of claim 1, wherein said belt-like elastic ring and said housing are made of a thermoplastic elastomer.

9. The vibrating band of claim 8, wherein said belt-like elastic ring and said housing are made of styrene-ethylene/butylene-styrene block copolymers.

10. The vibrating band of claim 1, wherein said flexible circuitry board is made of polyimide film.

11. The vibrating band of claim 1, wherein said flexible circuitry board contains a copper overlay.

12. The vibrating band of claim 1, wherein said touch switch is an on-off switch.

13. The vibrating band of claim 1, wherein said touch switch is a single speed switch.

14. The vibrating band of claim 1, wherein said touch switch is a variable switch with multiple settings to vary the intensity and speed of said vibration motor.

15. The vibrating band of claim 14, wherein said touch switch is a dome switch, a dimple switch or a momentary button switch.

16. The vibrating band of claim 1, wherein said touch switch can be controlled remotely by a wireless control.

17. The vibrating band of claim 1, wherein said vibrating motor has a thickness of about 2 to 5 mm and a diameter of from about 5 to 20 mm.

18. The vibrating band of claim 1, wherein said one or more batteries have a thickness of from about 2 to 5 mm and a diameter of from about 5 to 20 mm.

19. The vibrating band of claim 1, wherein said vibrating motor is capable of being pulsed.
